(19) United States
(12) Patent Application Publication
(10) Pub. No.: US 2020/0023998 A1
(43) Pub. Date: Jan. 23, 2020

(54) APPARATUS FOR STORING AIRPLANES

(71) Applicant: Barton Francis PAWLUSKI, Edmonton, AB (CA)

(72) Inventor: Barton Francis PAWLUSKI, Edmonton, AB (CA)

(21) Appl. No.: 16/471,732

(22) PCT Filed: Dec. 20, 2017
(86) PCT No.: PCT/CA2017/051558

§ 371 Date: Jun. 20, 2019

Related U.S. Application Data
(60) Provisional application No. 62/436,421, filed on Dec. 20, 2016.

(51) Int. Cl. B64F 1/22; E04H 6/44; B64F 1/24

(52) U.S. Cl. CPC B64F 1/222; B64F 1/24; E04H 6/44

(57) ABSTRACT

An apparatus for storing airplanes includes a first airplane parking floor at a first elevation, a second airplane floor at a second elevation, and an elevator. The first airplane parking floor defines a vacant region within a notional circle circumscribing the first airplane parking floor and defining a notional circumcenter. The first floor is rotatable about the circumcenter for selective angular alignment of one of several first airplane parking floor regions or the vacant region with a fixed sector of the circle. The second airplane parking floor is rotatable, at the second elevation, about the circumcenter for selective angular alignment of one of several second airplane parking floor region with the vacant region. When so aligned, the second airplane parking floor region may be vertically translated by the elevator between the second elevation and the vacant region at the first elevation.

### TECHNICAL FIELD

The present invention relates to apparatuses for storing airplanes.

### BACKGROUND OF THE INVENTION

Airplanes are stored in hangars to secure them and protect them from damaging environmental elements such as ultraviolet radiation and extreme temperatures. However, construction costs, operating costs, land scarcity, and other practical considerations limit the size of hangars. Accordingly, economical use of hangars requires airplanes to be stored in a space efficient manner.

In order to conserve space within hangars, airplanes may be parked so that the wings of different airplanes horizontally interleave or vertically overlap each other. However, positioning airplanes in such close proximity is inconvenient and difficult for a single person, and raises the risk of “hangar rash”—i.e., damage to the airplanes due to contact between the airplanes during ground handling.

The prior art includes apparatuses for storing airplanes that include elevators for moving airplanes between ground level and elevated rotatable platforms. Examples of such apparatuses are disclosed in U.S. Pat. No. 3,599,809 (Gresham), U.S. Pat. No. 3,670,464 (Cutter), U.S. Pat. No. 3,675,378 (Neumann et al.), U.S. Pat. No. 3,915,319 (Fairburn), and International Patent Application Publication WO 2013/057706 (Schaetz). It will be appreciated that in the use of such apparatuses, the airplanes must first be moved from the elevated platform onto the elevators before being lowered to ground level. Further, since the elevators must be large enough to support an airplane, such apparatuses make suboptimal use of hangar space if the elevators are placed inside the hangars.

U.S. Pat. No. 4,697,392 (Silzle) discloses an apparatus having a lower platform for supporting airplanes and raised lifting platforms for supporting additional airplanes in a nested configuration with the airplanes on the lower platform. The lifting platforms radiate from the central axis and rotate in unison with the lower platform about the central axis. A hydraulic piston moves the lifting platforms on pivoting levers so that the lifting platforms move simultaneously downwardly and radially outward from the central axis beyond the periphery of a lower platform so as to project through an open door of the hangar. It will be appreciated that use of the hangar space is suboptimal if the lifting platforms are to remain inside the hangar at all times, since the lifting platforms extend beyond the periphery of the lower platform when lowered.

Additional examples of apparatuses for ground handling and/or storing airplanes are disclosed in U.S. Pat. No. 3,954,197 (Dean), U.S. Pat. No. 5,141,371 (Pish), U.S. Pat. No. 6,155,003 (Smith), U.S. Pat. No. 6,672,221 (Hadley), U.S. Pat. No. 7,465,141 (Fournier et al.), U.S. Patent Application Publication 2006/0038069 (Cawley), U.K. Patent Application Publication GB 2,376,005 (Haig), International Patent Application Publication WO 96/13428 (Leonard), and German Patent Application Publication DE 3545888 A1 (Schaetz).

### SUMMARY OF THE INVENTION

An objective of the present invention is to provide an apparatus suitable for use inside hangars that allows for space-efficient storage of airplanes. Another objective of the present invention is to provide an apparatus for storing airplanes that allows for convenient movement of airplanes between airplane parking floors at different elevations, and positions for ingress and egress from a hangar, by a single operator and with limited towing or moving of airplanes. Another objective of the present application is to provide an apparatus for storing airplanes that selectively restricts access to airplanes to authorized operators. Other objectives of the present invention may include providing an apparatus that reduces the risk of contact between airplanes in hangars, and helps to control the temperature inside hangars when airplanes enter and exit through hangar door openings. It will be understood, however, that the foregoing aspirations of the present invention are not promised advantages of any particular embodiment of the present invention.

In one aspect, the present invention comprises an apparatus for storing airplanes. The apparatus comprises a first airplane parking floor at a first elevation, and a second airplane parking floor at a second elevation different from the first elevation, and an elevator.

The first airplane parking floor is shaped to define a vacant region at the first elevation in which the first airplane parking floor is absent. The vacant region is positioned within a notional circle circumscribing the first airplane parking floor at the first elevation and defining a notional circumcenter.

The second airplane parking floor comprises a plurality of separable second airplane parking floor regions, each of which is proportioned for parking one of the airplanes thereon. The second airplane parking floor is rotatable about the circumcenter for selective angular alignment of an individual one of the second airplane parking floor regions with the vacant region.

The elevator vertically translates the individual one of the second airplane parking floor regions, when in angular alignment with the vacant region, between the second elevation and the vacant region at the first elevation.

In embodiments of the apparatus, the first airplane parking floor comprises a plurality of first airplane parking floor regions, each of which is proportioned for parking one of the airplanes thereon. In embodiments, the first airplane parking floor regions may be separable from each other.

In embodiments of the apparatus, the first airplane parking floor is rotatable about the circumcenter, for selective angular alignment of an individual one of the first airplane parking floor regions or the vacant region within a fixed sector of the notional circle.

In embodiments of the apparatus, the apparatus may further comprise at least one pair of first walls attached to and extending upwardly from the first airplane parking floor for separating one of the first airplane parking floor regions from an adjacent one or adjacent ones of the first airplane parking floor regions.

In embodiments of the apparatus, the apparatus may further comprise a first access wall extending along an outer edge of one of the first airplane parking floor regions. The first airplane parking floor may rotate relative to the first access wall when the first airplane parking floor rotates about the circumcenter. The first access wall may define an opening for a human to move into and out of the one of the first airplane parking floor regions.

In embodiments of the apparatus, the apparatus further comprises at least one pair of second walls attached to and extending upwardly from the second airplane parking floor for separating one of the second airplane parking floor regions from an adjacent one or adjacent ones of the second airplane parking floor regions.

In embodiments of the apparatus, the apparatus further comprises an access floor at the second elevation, adjacent to at least a portion of the edge of the second airplane parking floor, and extending radially away from the circumcenter.

In embodiments of the apparatus, the apparatus further comprises a second access wall extending along an outer edge of one of the second airplane parking floor regions. The second airplane parking floor may rotate relative to the second access wall when the second airplane parking floor rotates about the circumcenter. The second access wall may define an opening for a human to move into and out of the one of the second airplane parking floor regions.

In embodiments of the apparatus, the elevator is positioned to selectively engage the individual one of the second airplane parking floor regions in angular alignment with the vacant region, without engaging the other one or ones of the second airplane parking floor regions that are not in angular alignment with the vacant region.

### BRIEF DESCRIPTION OF DRAWINGS

In the drawings, like elements are assigned like reference numerals. The drawings are not necessarily to scale, with the emphasis instead placed upon the principles of the present invention. Additionally, each of the embodiments depicted is but one of a number of possible arrangements utilizing the fundamental concepts of the present invention. The drawings are briefly described as follows:

FIG. 1 is a perspective view of one embodiment of an apparatus of the present invention for storing airplanes, shown with parked airplanes;

FIG. 2 is a top plan view of a first airplane parking floor of the apparatus shown in FIG. 1;

FIG. 3 is a perspective view of the structure and elevator of the apparatus shown in FIG. 1;

FIG. 4 is a front elevation view of the structure and elevator shown in FIG. 3;

FIG. 5 is a top plan view of the structure shown in FIG. 3 as viewed along line E-E of FIG. 4;

FIG. 6 is a top plan view of the structure shown in FIG. 3 as viewed along line F-F of FIG. 4;

FIG. 7 is a front elevation view of the apparatus shown in FIG. 1;

FIG. 8 is a top plan view of the apparatus shown in FIG. 1 as viewed along line A-A of FIG. 7;

FIG. 9 is a top plan view of the apparatus shown in FIG. 1 as viewed along line B-B of FIG. 7;

FIG. 10 is a perspective view of an embodiment of an airplane parking floor panel upper layer of the apparatus shown in FIG. 1;

FIG. 11 is a bottom plan view of an embodiment of an airplane parking floor panels of the apparatus shown in FIG. 1;

FIG. 12 is a detailed view of region A of FIG. 3, showing a second motor for rotating the second airplane parking floor;

FIG. 13 is a perspective view of the elevator shown in FIG. 3;

FIG. 14 is a perspective view of the apparatus shown in FIG. 1, with first walls, second walls and access walls;

FIG. 15 is a perspective view of the apparatus shown in FIG. 14, inside a hangar; and

FIGS. 16A to 16H are successive perspective views showing an exemplary use and operation of the apparatus shown in FIG. 14.

### DETAILED DESCRIPTION OF THE INVENTION

The present invention relates to an apparatus for storing airplanes. Any term or expression not expressly defined herein shall have its commonly accepted definition understood by a person skilled in the art.

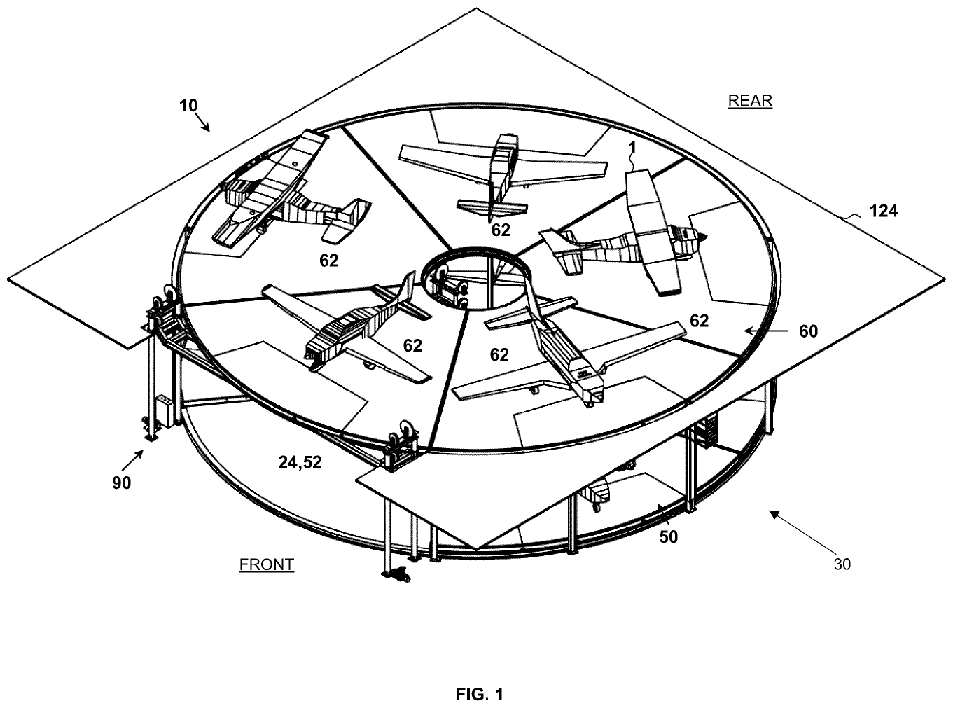

Apparatus in general. In an exemplary embodiment as shown in FIG. 1, the apparatus (10) comprises a structure (30) (shown more clearly in FIG. 3), a first airplane parking floor (50) at a first elevation, a second airplane parking floor (60) at a second elevation different than the first elevation, and an elevator (90).

In the exemplary embodiment shown in FIG. 1, the first elevation is substantially at ground level, and the second elevation is above ground level. For example, the first elevation may be substantially level with the top surface of an apron in front of a hangar door, with the structure underlying the first airplane parking floor (30) recessed below the top surface of the apron. In other embodiments (not shown) the first elevation may be above or below ground level, and the second elevation may be below the first elevation.

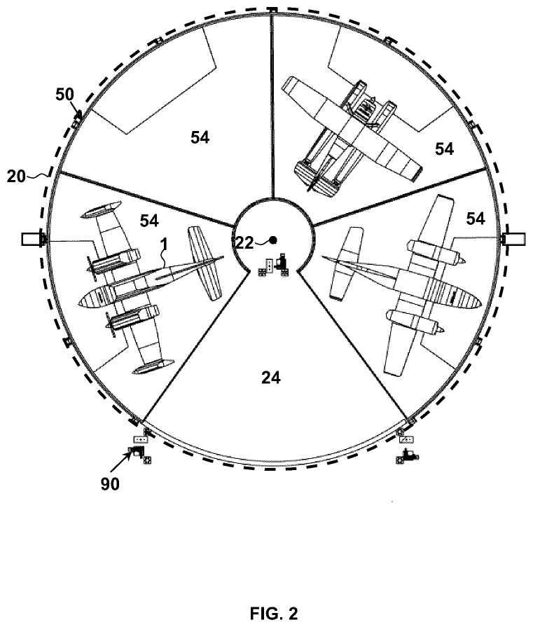

In the following description, and as shown in FIG. 2, the relationship between the structure (30), the first airplane parking floor (50), the second airplane parking floor (60), and the elevator (90) are described with reference to a notional circle (20) that circumscribes the first airplane parking floor (50) at the first elevation, defines a notional circumcenter (22), and defines a fixed sector (24). As used herein, the term “circumscribes” means that the notional circle (20) is the smallest horizontally oriented circle at the first elevation that completely contains the first airplane parking floor (50). As used herein, the term “circumcenter” refers to the center of such a circumscribed notional circle (20). As used herein, the term “sector” refers to a region of such a circumscribed notional circle (20) that is bound by two radii of the notional circle (20). As used herein, the term “central angle”, in relation to the fixed sector (24), is the angle having the notional circumcenter (22) as the apex and defined between the two bounding radii of the fixed sector (24). As used herein, the term “angular alignment” in describing the spatial relationship between two components of the apparatus (10) means that both components may be intersected by a vertically extending plane projected radially from the notional circumcenter (22).

In the exemplary embodiment of the first airplane parking floor (50) shown in FIG. 2, the notional circle (20) is shown with a dashed line and its notional circumcenter (22) is shown as a point, and its fixed sector (24) is shown as towards the bottom of FIG. 2. For clarity of FIG. 2, the notional circle (20) is shown as slightly separated from the outer edge of the first airplane parking floor (50), but it will be understood that the notional circle (20) is touching portions of the outer edge of the first airplane parking floor (50).

In the exemplary embodiment shown in FIG. 1, the apparatus (10) is used to store at total of nine fixed wing airplanes (four on the first airplane parking floor (50), and five on the second airplane parking floor (60)), each of the airplanes having a wingspans of approximately 10 meters (33 feet), such as a Cirrus™ model SR22, Cessna™ models 185 (on amphibious floats), 340, 421, or a Piper Meridian™. It will be understood that these examples are non-limiting of the present invention. Accordingly, in the exemplary use, the apparatus (10) is scaled such that the notional circle (20) has a diameter of approximately 30 meters (100 feet). Further, the central angle of the fixed sector (24) is selected to be approximately 72 degrees so that the chord extending between the end points of the arc defined by the fixed sector (24) spans approximately 18 meters (60 feet). Further, in the exemplary embodiment in FIG. 1, opposite end of the apparatus (10) have been labelled as “FRONT” and “REAR” for convenient reference. In exemplary use, as shown in FIG. 15, the apparatus (10) may be installed inside a hangar, with the portion of the apparatus (10) most proximal to “FRONT” being placed adjacent to a hangar door (e.g., a bi-fold type door or other types of doors) for ingress and egress of airplanes from the hangar. In other embodiments (not shown), the apparatus (10) may be scaled to suit different numbers or sizes of airplanes and different sizes of hangars.

Structure. In the exemplary embodiment, a purpose of the structure (30) is to guide the rotation of the second airplane parking floor (60) about the notional circumcenter (22) at the second elevation. In the exemplary embodiment, another purpose of the structure (30) may be to guide the rotation of the first airplane parking floor (50) about the notional circumcenter (22) at the first elevation. In the exemplary embodiment, still another purpose of the structure (30) is to support the second airplane parking floor (60) and any airplanes parked thereon at the second elevation.

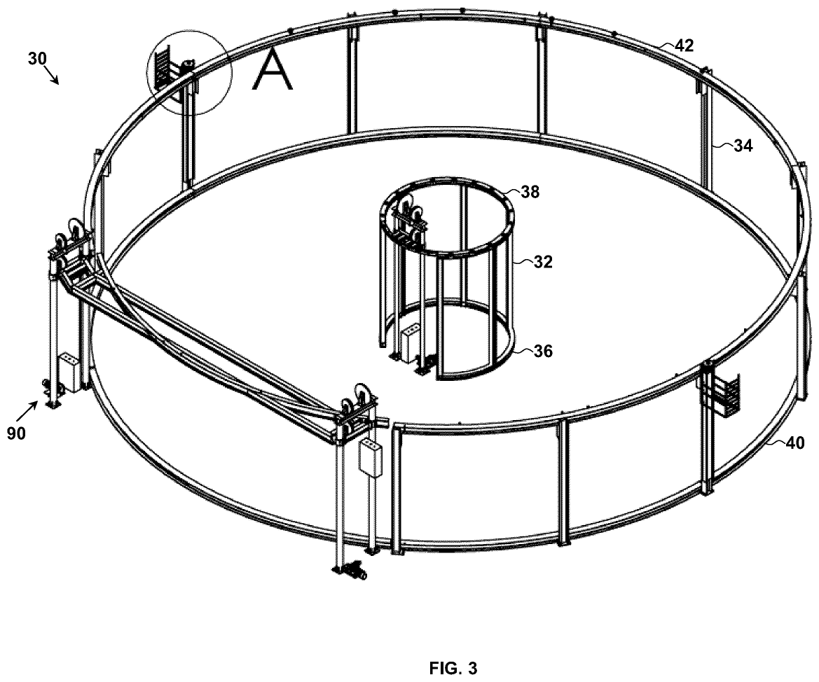

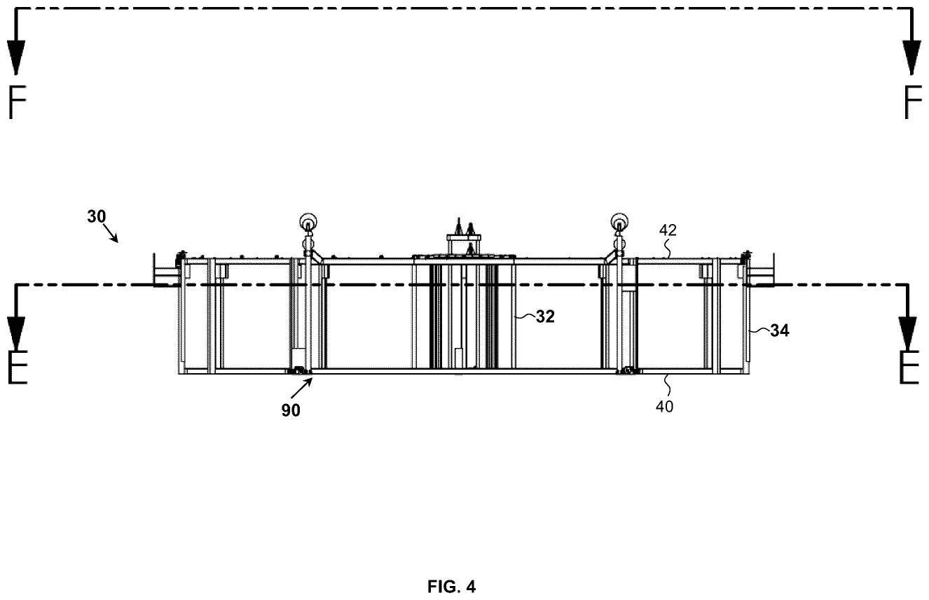

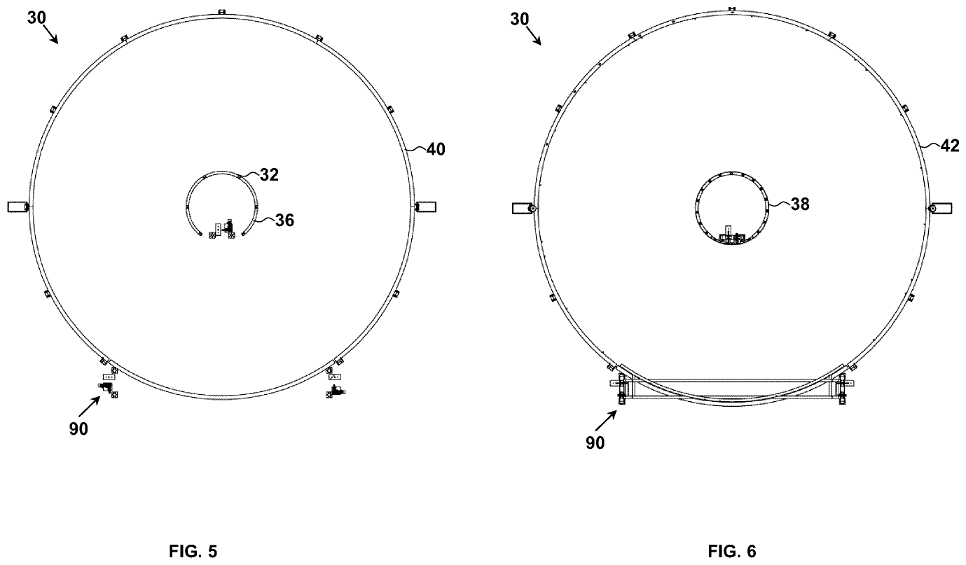

In the exemplary embodiment as shown in FIGS. 3 to 6, the structure (30) comprises a plurality of structure inner columns (32), structure outer columns (34), structure first inner beams (36), structure second inner beams (38), structure first outer beams (40) and structure second outer beams (42), all of which are members having I-shaped cross-sections and made of structural grade steel. In other embodiments (not shown), the structure (30) may be made of different types and numbers of members, arranged in different configurations, and made of different materials that are suitably strong and rigid (e.g., other metal alloys, wood or composite materials as non-limiting examples).

In the exemplary embodiment shown in FIGS. 3 to 6, the structure inner columns (32) and structure outer columns (34) may have a height of about 6 meters (20 feet) so as to support the second airplane parking floor (60) at approximately this height above ground level. The structure inner columns (32) and structure outer columns (34) are laid out in substantially circular arrangements centered at the notional circumcenter (22), with diameters of about 4.5 meters (15 feet) and 30 meters (100 feet), respectively. However, no structure outer columns (34) are positioned in the fixed sector (24) so as to permit free passage of airplanes (1) into and out of the fixed sector (24).

In the exemplary embodiment shown in FIGS. 3 to 6, the structure first inner beams (36) and structure second inner beams (38) span between adjacent ones of the structure inner columns (32) at the first elevation and the second elevation, respectively. The structure first outer beams (40) and the structure second outer beams (42) span between adjacent ones of the structure outer columns (34) at the first elevation and the second elevation, respectively. However, it will be noted that the section of the structure first inner beams (36) and the section of the structure second outer beams (42) that spans between the structure inner columns (32) and the structure outer columns (34), respectively, in the fixed sector (24) are off-set radially from the rest of the structure first inner beams (36) and the structure second outer beams (42) in order to accommodate the placement of the elevator (90). Further, it will be noted that the structure first outer beams (40) provides support for components of the elevator (90), but remain stationary.

In the exemplary embodiment shown in FIGS. 3 to 6, the structure first inner beams (36), and the structure second inner beams (38) are curved so that they form a substantially circular track and an arcuate track, respectively, at the first elevation and the second elevation, respectively. Likewise, the structure first outer beams (40), and the structure second outer beams (42) are curved so that they form a substantially circular track and an arcuate track, respectively, at the first elevation and the second elevation, respectively. These circular and arcuate tracks guide rotation of the first airplane parking floor (50) and the second airplane parking floor (60) about the notional circumcenter (22), as is described below. In other embodiments (not shown), the structure first inner beams (36), the structure second inner beams (38), the structure first outer beams (40), and the structure second outer beams (42) may be straight, but provided with guide rollers so as to define circular tracks for the first airplane parking floor (50) and the second airplane parking floor (60).

First Airplane Parking Floor. A purpose of the first airplane parking floor (50) is to allow for parking of one or more airplanes (1) thereon at the first elevation. Another purpose of the first airplane parking floor (50) is to define a vacant region (52) at the first elevation in which the first airplane parking floor (50) is absent within the notional circle (20), which vacant region (52) is or may be positioned in the fixed sector (24).

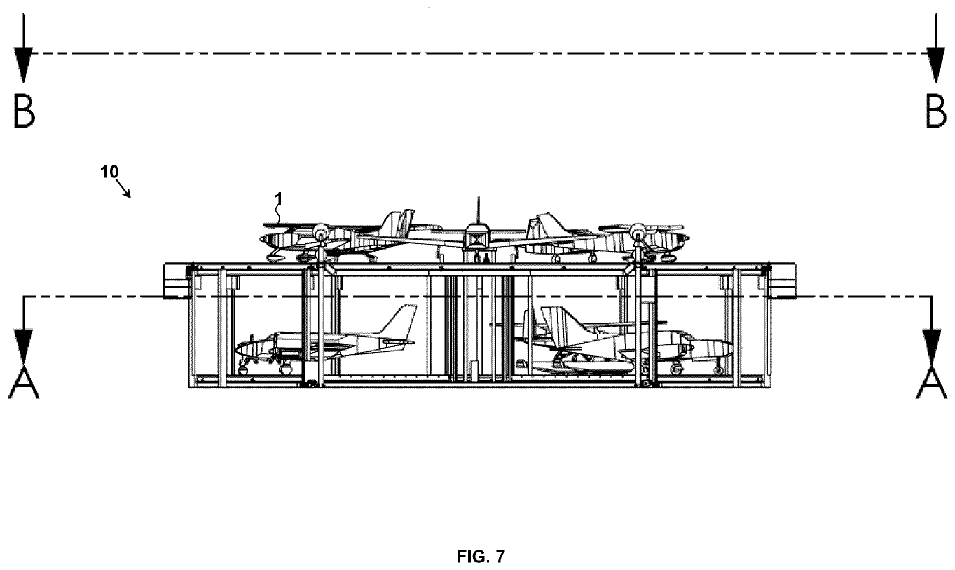

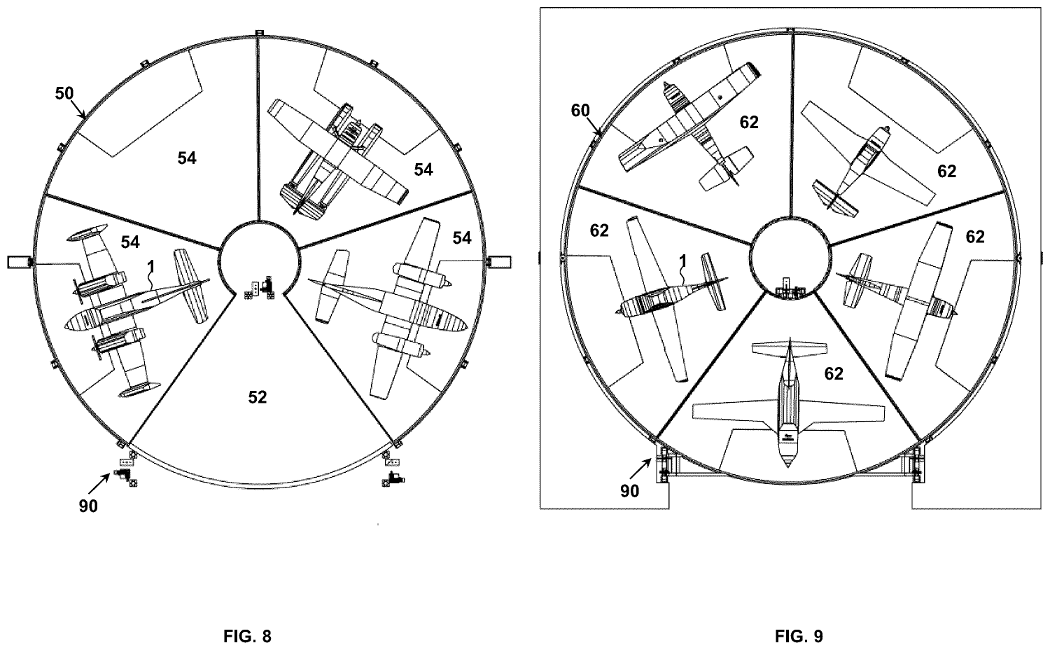

In the exemplary embodiment shown in FIG. 8, the first airplane parking floor (50) has a substantially arcuate shape subtending a central angle of approximately 288 degrees, and thus defining a vacant region (52) that may be positioned in angular alignment and substantially co-extensive with the fixed sector (24) of the notional circle (20). Further, the first airplane parking floor (50) comprises four first airplane parking floor regions (54), each proportioned for parking one of the airplanes (1) thereon, and having an arcuate shape subtending a central angle of approximately 72 degrees. In other embodiments (not shown), the first airplane parking floor (50) may have a different shape and comprise a lesser or greater number of first airplane parking floor regions (54). Further, in other embodiments (not shown), different first airplane parking floor regions (54) may have different shapes and sizes from each other. For example, a first one of the first airplane parking floor regions (54) may have an arcuate shape subtending a central angle of about 144 degrees, while smaller second and third ones of the first airplane parking floor regions (54) each have an arcuate shape subtending a central angle of about 72 degrees.

In the exemplary embodiment shown in the FIG. 8, the first airplane parking floor (50) is formed by four separate airplane parking floor panels (70) (as described below), each of which corresponds to one of the first airplane parking floor regions (54). In other embodiments, it will be appreciated that the first airplane parking floor (50) may be formed by a single member or other numbers of members that do not necessarily correspond to the number of first airplane parking floor regions (54).

In the exemplary embodiment of the apparatus, the first airplane parking floor (50) is rotatable about the notional circumcenter (22), for selective angular alignment of an individual one of the first airplane parking floor regions (54) or the vacant region (52) within the fixed sector (24) of the notional circle (20). In other embodiments (not shown), the first airplane parking floor (50) may be non-rotatable about the circumcenter, such that the vacant region (52) is in fixed position with the fixed sector (24) of the notional circle (20).

Second Airplane Parking Floor. A purpose of the second airplane parking floor (60) is to allow for parking of one or more airplanes (1) thereon at the second elevation.

In the exemplary embodiment shown in FIG. 9, the second airplane parking floor (60) has an annular shape. Further, the second airplane parking floor (60) comprises five separable second airplane parking floor regions (62), each proportioned for parking one of the airplanes (1) thereon. In other embodiments (not shown), the second airplane parking floor (60) may have a different shape and comprise a lesser or greater number of second airplane parking floor regions (62). Further, in other embodiments (not shown), different second airplane parking floor regions (62) may have different shapes and sizes from each other. For example, a first one of the second airplane parking floor regions (62) may have an arcuate shape subtending a central angle of about 144 degrees, while smaller second and third ones of the second airplane parking floor regions (62) each have an arcuate shape subtending a central angle of about 72 degrees. It will be appreciated, however, that the largest of the second airplane parking floor regions (62) should be shaped and proportioned to fit within the vacant region (52) when lowered to the first elevation.

In the exemplary embodiment shown in the FIG. 9, the second airplane parking floor (60) is formed by five airplane parking floor panels (70) (as described below), each of which corresponds to one of the second airplane parking floor regions (62). In other embodiments, it will be appreciated that the second airplane parking floor (60) may be formed by a single member or other numbers of members that do not necessarily correspond to the number of second airplane parking floor regions (62).

The second airplane parking floor (60) is attached to the structure (30) for rotating about the notional circumcenter (22) for selective angular alignment of an individual one of the second airplane parking floor regions (62) with the vacant region (52), when the vacant region (52) is in angular alignment with the fixed sector (24).

Airplane Parking Floor Panel. In the exemplary embodiments, the first airplane parking floor (50) shown in FIG. 8 and the second airplane parking floor (60) shown in FIG. 9, are formed by a plurality of arcuate airplane parking floor panels (70). The airplane parking floor panels (70) extend radially away from the notional circumcenter (22) to the edge of the first airplane parking floor (50) or the second airplane parking floor (60), as the case may be.

In the exemplary embodiment, each airplane parking floor panel (70) comprises an airplane parking floor panel upper layer (72) supported by an airplane parking floor panel support frame (74). The airplane parking floor panel (70) may also comprise attached airplane parking floor panel support rolling elements (76).

In one exemplary embodiment, the airplane parking floor panel support rolling elements (76) are positioned between the outermost radial support beam of the airplane parking floor panel support frame (74) and the structure first outer beams (40) or the structure second outer beams (42) (as the case may be) and between the innermost radial support beam of the airplane parking floor panel support frame (74) and the structure first inner beams (36) or the structure second inner beams (38) (as the case may be). The airplane parking floor panel support rolling elements (76) are positioned such that they provide support for the weight of the airplane parking floor (70), and any airplanes (1) positioned thereon, and allow the airplane parking floor (70) to rotate about the notional circumcenter (22) as further described below. In one exemplary embodiment, the airplane parking floor panel support rolling elements (76) are positioned along the centerline of the outermost or innermost radial support beams of the airplane parking floor panel support frame (74) and the structure first or second outer or inner beams (40, 42, 36 or 38). In one exemplary embodiment, the airplane parking floor panel support rolling elements (76) are comprised of two side-by-side rollers mounted on an axial, which are positioned approximately symmetrically on either side of the centerline of the outermost or innermost radial beams of the airplane parking floor panel support frame (74) and the structure first or second outer or inner beams (40, 42, 36 or 38). It will be appreciated that alternative alignment and combinations of rollers would be known to a skilled person to provide the support and rotating functions of the airplane parking floor panel support rolling elements (76).

In one exemplary embodiment, the airplane parking floor panel support rolling elements (76) can be mounted on or attached to the outermost radial support beam of the airplane parking floor panel support frame (74) and/or the innermost radial support beam of the airplane parking floor panel support frame (74). In another exemplary embodiment, the airplane parking floor panel support rolling elements (76) can be mounted on or attached to the structure first outer beams (40), the structure second outer beams (42), the structure first inner beams (36) and/or the structure second inner beams (38). It will be understood that the airplane parking floor panel support rolling elements (76) can be mounted on or attached to the outermost or innermost beams of the airplane parking floor panel support frame (74) and/or the structure first or second outer or inner beams (40, 42, 36 or 38) in any functional combination. When the airplane parking floor panel support rolling elements (76) are mounted on or attached to either structure inner or outer support beams (40, 42, 36 or 38) they do not form part of the airplane parking floor panel (70).

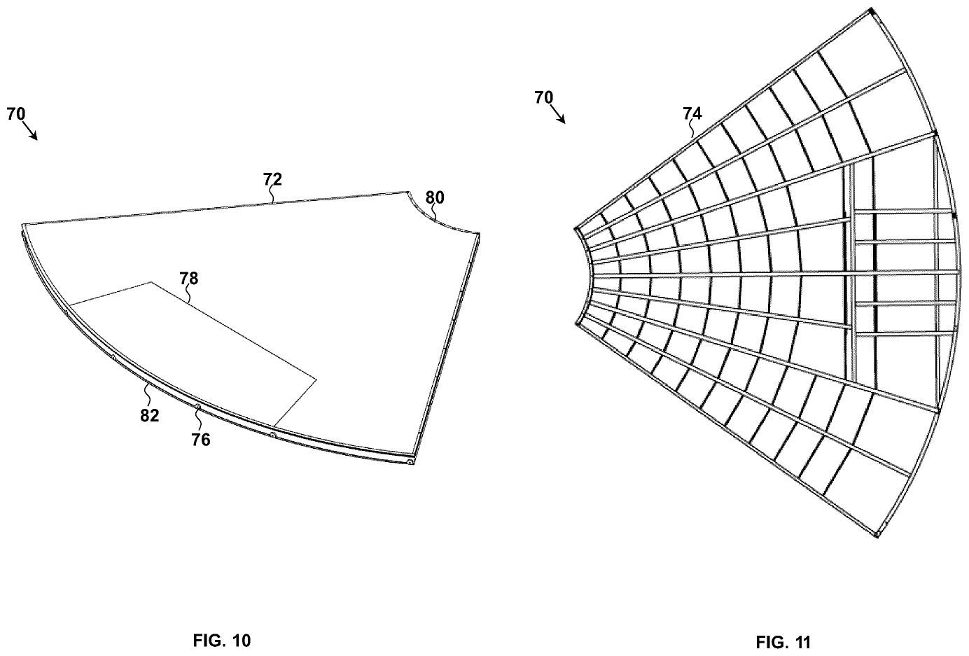

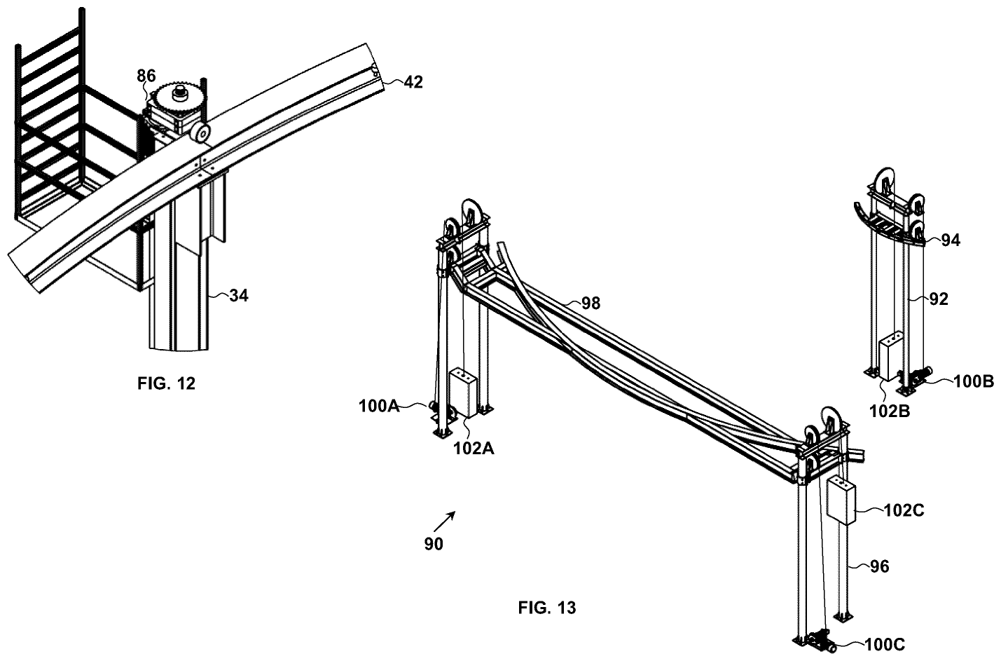

The airplane parking floor panel upper layer (72) provides an upward facing surface on which airplanes (1) may be parked. In the exemplary embodiment shown in FIG. 10, the airplane parking floor panel upper layer (72) is made of structural grade steel. In other embodiments, the parking floor panel upper layer (72) may be made of any material that is suitably strong and durable to support airplanes (1) and withstand airplane traffic thereon (e.g., other metal alloys, wood or composite materials as non-limiting examples), and may define perforations (e.g., a grating) to allow for drainage. In the exemplary embodiment, the airplane parking floor panel upper layer (72) comprises an airplane parking floor panel upper layer removable portion (78) that may be removed to permit access to the underlying airplane parking floor panel support frame (74).

The airplane parking floor panel support frame (74) provides structural support for the airplane parking floor panel upper layer (72). In the exemplary embodiment shown in FIG. 11, the airplane parking floor panel support frame (74) comprises a plurality of members arranged to form a series of radially extending beams interconnected by circumferentially extending joists. The members of the parking floor panel lower layer may be made of structural grade steel, but in other embodiments, may be made of any material that is suitably strong and rigid to support the weight of the airplanes (1) (e.g., other metal alloys, wood or composite materials as non-limiting examples). In the exemplary embodiment, the position of at least some of the members of the airplane parking floor panel support frame (74) are selectively adjustable in position to accommodate different load patterns of different airplanes (1). For example, the beams and joists of the airplane parking floor panel support frame (74) that are exposed when the airplane parking floor panel upper layer removable portion (78) is removed, may be selectively adjusted in position so that they are disposed near or underneath the nose wheel or main landing gear wheels of one of the airplanes (1).

In other embodiments (not shown), the airplane parking floor panels (70) may be constructed with different types of members and materials, and different suitable construction techniques known in the art, depending on factors such as the size and weight of airplanes (1) to be supported thereon, and the desired weight, shape and size of the airplane parking floor panels (70) themselves.

Rotatable Attachment of Airplane Parking Floors to Structure. The airplane parking floor panel support rolling elements (76) and the airplane parking floor panel guide elements (not shown), allow for rotation of the first airplane parking floor (50) and the second airplane parking floor (60) about the notional circumcenter (22). In the exemplary embodiment of the apparatus (10), the plurality of airplane parking floor panel guide elements comprise rotatable wheels or bearing elements attached to the airplane parking floor panels (70) with mounting brackets at or near the airplane parking floor panel inner edge (80) and the airplane parking floor panel outer edge (82), in order to guide the airplane parking floor panels (70) along the structure first inner beams (36) or structure second inner beams (38) (as the case may be) and the structure first outer beams (40) or the structure second outer beams (42) (as the case may be). In an exemplary embodiment, the plurality of airplane parking floor panel guide elements may be positioned so that they substantially coincide with the centerline of the structure first inner beams (36) or structure second inner beams (38) (as the case may be) and the structure first outer beams (40) or the structure second outer beams (42) (as the case may be).

In the case of the first airplane parking floor (50), the airplane parking floor panel guide elements at or near the airplane parking floor panel inner edge (80) and the airplane parking floor panel outer edge (82) of each airplane parking floor panel (70) roll along the substantially circular tracks formed by the structure first inner beams (36) and the structure first outer beams (40).

In the case of the second airplane parking floor (60), the airplane parking floor panel guide elements on the airplane parking floor panel inner edge (80) and the airplane parking floor panel outer edge (82) of each airplane parking floor panel (70) roll along the substantially arcuate tracks formed by the structure second inner beams (38) and the structure second outer beams (42). In alternate embodiments, the airplane parking floor panel guide elements can be bumpers or stationary guides. It would be understood by a skilled person that alternate alignment and positioning of the airplane parking floor panel guide elements is possible to provide the same function of guiding the rotating airplane parking floor panels (70) about the notional circumcenter (22).

Means for Rotating Airplane Parking Floors. In the exemplary embodiment, the apparatus (10) may further comprise a means for rotating the first airplane parking floor (50) about the notional circumcenter (22). A purpose of the means for rotating the first airplane parking floor (50) is to selectively position the vacant region (52) or a selected one of the first airplane parking floor regions (54) in angular alignment with the fixed sector (24). In the exemplary embodiment, the means for rotating the first airplane parking floor (50) comprises a first motor (not shown) in driving engagement with the first airplane parking floor (50) that powers rotation of the first airplane parking floor (50) about the notional circumcenter (22). The driving engagement between the first motor and the first airplane parking floor (50) may be analogous to the driving engagement between the second motor (86) and the second airplane parking floor (60) (as is described below). In other embodiments (not shown), the rotatable motion of the first airplane parking floor (50) about the notional circumcenter (22) may be achieved by other means. It will be appreciated that the first airplane parking floor (50) may or may not be attached to the structure (30) for this purpose.

In the exemplary embodiment, the apparatus (10) may further comprise a means for rotating the second airplane parking floor (60) about the notional circumcenter (22). A purpose of the means for rotating the second airplane parking floor (60) is to selectively position a selected one of the second airplane parking floor regions (62) in angular alignment with the vacant region (52). In the exemplary embodiment as shown in FIG. 6, the means for rotating the second airplane parking floor (60) comprises a second motor (86) in driving engagement with the second airplane parking floor (60) that powers rotation of the second airplane parking floor (60) about the notional circumcenter (22). In the exemplary embodiment, the driving engagement between the second motor (86) and the second airplane parking floor (60) is effected by a gear mechanism between the motor and the second airplane parking floor (60).

In embodiments, the means for rotating one of the airplane parking floors (50 or 60) may comprise one or a combination of types of drive systems that engage the parking floor panel outer edge (82). Examples include a sprocket drive mechanism that engages either a chain mounted on the parking floor panel outer edge (82), or slots cut into the parking floor outer edge (82). Alternatives may include a driving pinion gear on an output shaft of the first and/or second motors or a gearbox output shaft of the first and/or second motors, and a gear rack or flexible timing belt around the parking floor outer edge (82). In other cases, the outer beams (40 or 42) may be driven by a contacting drive roller that either presses against the parking floor outer edge (82), or sets of rollers that “pinch” the parking floor outer edge (82). In the foregoing examples, the principle of operation is to apply a tangential force to the parking floor outer edge (82), which in conjunction with the airplane parking floor panel support rolling elements (76) and the airplane parking floor panel guide elements around the parking floor inner and outer edges (80 and 82), causes rotation of the parking floors (50 or 60) about the notional circumcenter (22).

In embodiments, the driving engagement between the first motor or second motor (86) and the first airplane parking floor (50) and the second airplane parking floor (60) may be implemented by a variety of suitable means known in the art. One non-limiting example is a rack and pinion mechanism comprising a circular gear that is rotated by the first motor or the second motor (86) and that engages a geared circular linear track attached to the first airplane parking floor (50) or second airplane parking floor (60), respectively. Another non-limiting example is a sprocket and roller mechanism comprising a first sprocket that is rotated by the first motor (84) or the second motor (86) and that meshes with a roller chain that engages a second sprocket attached to the first airplane parking floor (50) or the second airplane parking floor (60), respectively. Still another non-limiting example of a suitable means comprises one or more rollers that are rotated by the first motor or the second motor (86) and that engage by friction the first airplane parking floor (50) or the second airplane parking floor (60), respectively, to drive the rotation thereof.

Means for limiting rotational movement of airplane parking floors. In the exemplary embodiment, the apparatus (10) may comprise one or more means (not shown) for selectively limiting rotational movement of the first airplane parking floor (50), or the second airplane parking floor (60) or both about the notional circumcenter (22). As used in this context “limiting rotational movement” includes preventing rotational movement. In the case of the first airplane parking floor (50), a purpose of such means is to prevent unintentional misalignment of the vacant region (52) or a selected one of the first airplane parking floor regions (54) after being selectively positioned in angular alignment with the fixed sector (24). In the case of the second airplane parking floor (60), a purpose of such means is to prevent unintentional misalignment of a selected one of the second airplane parking floor regions (62) after being selectively positioned in angular alignment with the fixed sector (24) in engagement with the elevator (90). The means for limiting rotational movement of the airplane parking floors may comprise any suitable mechanism known in the art. Without limiting the generality of the foregoing, such means may comprise an electro-mechanically actuated latching mechanism that can be selectively actuated to engage the airplane parking floor regions so as to limit rotational movement relative to the structure (30) and/or the elevator (90).

Elevator. A purpose of the elevator (90) is to provide a mechanism for vertically translating an individual one of the second airplane parking floor regions (62), when in angular alignment with the vacant region (52), between the second elevation and the vacant region (52) at the first elevation.

In the exemplary embodiment shown in FIGS. 3 and 13, the elevator (90) is a hoist mechanism that comprises two horizontally spaced-apart stationary elevator inner columns (92), an elevator inner beam (94) spanning between the pairs of elevator inner columns (92), two horizontally spaced-apart pairs of stationary elevator outer columns (96), and an elevator outer beam (98) spanning between the pairs of elevator outer columns (96). The elevator inner beam (94) and the elevator outer beam (98) are attached to the elevator inner columns (92) and the elevator outer columns (96), respectively, for vertical translation thereon, in unison, between the first elevation and the second elevation.

In the exemplary embodiment, as shown in FIGS. 3 and 13, a drive mechanism (100) (comprising three separate drive mechanisms (100A, 100B, 100C)) are in driving engagement with the elevator inner beam (94) and the elevator outer beam (98) to vertically translate the elevator inner beam (94) and the elevator outer beam (98) between the second elevation and the first elevation. In the exemplary embodiment, each drive mechanism (100A, 100B, 100C) includes a motor with an associated gearbox and braking mechanism, that drives a winch mechanism, to alternately wind and unwind cables (in the form of wire rope) attached to the elevator inner beam (94) and the elevator outer beam (98). The cable associated with drive mechanism (100B) pass over sets of the pulleys, in a block-and-tackle arrangement, associated with the elevator inner beam (94), with one end of the cable attached to the elevator inner beam (94) and an opposite end of the first cable attached to the winch for winding and unwinding the first cable. Likewise, a second cable and a third cable passes over sets of pulleys, in a block-and-tackle arrangement, associated with the elevator outer beam (98), with one end of each of second cable and third cable attached to the elevator outer beam (98) and an opposite end of each of the second cable and third cable attached to a second winch and third winch for winding and unwinding the second cable and the third cable, respectively. In alternative embodiments, the drive mechanism (100) may function by means of cylinders or screws as would be known to a person skilled in the art.

In the exemplary embodiment, the elevator (90) may comprise a VFD (variable frequency drive) to make minor adjustments to the speeds of three motors and associated gearboxes of the three drive mechanisms (100A, 100B, 100C) to help ensure that the elevator inner beam (94) and the elevator outer beam (98) raises or lowers the airplane parking floor panel (70) in relatively level fashion. In the exemplary embodiment, the elevator (90) may further comprise counter weights (102A, 102B, 102C) that reduce the required torque output of the drive mechanisms (100A, 100B, 100C) by offsetting the weight of an airplane parking floor panel (70) and any airplane (1) supported thereon. In alternative embodiments, the drive mechanism (100) may comprise a single motor that drives one or more drums to wind or unwind cables attached to the elevator inner beam (94) and the elevator outer beam (98) to help ensure that the airplane parking floor panel is raised and lowered in a relatively level orientation.

In the exemplary embodiment shown in FIGS. 3 and 13, the elevator inner beam (94) and the elevator outer beam (98) each comprise a curved portion that is analogous in structure to the structure second inner beams (38) and the structure second outer beams (42), respectively. Accordingly, when the elevator inner beam (94) and the elevator outer beam (98) are at the second elevation, the elevator inner beam (94) and the elevator outer beam (98) complete the arcuate tracks formed by the structure second inner beams (38) and the structure second outer beams (42), respectively, to form a complete circular track for the airplane parking floor panel inner edge (80) and the airplane parking floor panel outer edge (82), respectively, of the airplane parking floor panels (70) of which the second airplane parking floor (60) is comprised. In the exemplary embodiment of the apparatus (10), the length of curved portion of the elevator inner beam (94) and the elevator outer beam (98) are selected to match the length of airplane parking floor panel inner edge (80) and the airplane parking floor panel outer edge (82), respectively. Further, the curved portion of the elevator inner beam (94) and the elevator outer beam (98) are positioned in the fixed sector (24). Accordingly, the elevator (90) selectively engages an individual one of the second airplane parking floor panels (70) (and hence only one of the second airplane parking floor regions (62)), when that airplane parking floor panel (70) is rotated into angular alignment with the fixed sector (24). In the exemplary embodiment, when a selected one of the airplane parking floor panel (70) is engaged by the elevator, the elevator inner beam (94) and the elevator outer beam (98) can be vertically locked into position (e.g., with latching mechanisms between the structure (30) and the elevator inner beam (94) and the elevator outer beam (98)) so that the three drive mechanisms (100A, 100B, 100C) do not need to be continuously powered to maintain the elevation of the elevator inner beam (94) and the elevator outer beam (98).

In other embodiments (not shown), the elevator (90) may comprise other lifting mechanisms known in the art that are suitable for lifting or lowering the airplane parking floor panels (70). These may include, without limitation, a geared traction mechanism, cylinder or jack mechanisms (whether pneumatic hydraulic, screw-type, or otherwise mechanically or electro-mechanically actuated), a chain and sprocket mechanism, or a combination of the foregoing.

Means for controlling the apparatus. In exemplary embodiments, the apparatus (10) may further comprise a means for controlling the apparatus (not shown) that is operatively connected to the means for rotating the first airplane parking floor (50), the means for rotating the second airplane parking floor (60), the means for limiting rotational of the airplane parking floors, and the elevator (90).

In embodiments, the means for controlling the apparatus may comprise a computer comprising a processor operatively connected to a computer memory, an input device (such as a keypad or a touch-responsive display screen), a display device (such as a computer monitor or display screen), and an electric switch. In exemplary embodiments, the computer memory comprises a computer readable medium may store a set of instructions executable by the processor to implement a method that comprises the steps of: receiving a command via the input device to move a selected one of the first airplane parking floor regions (54) or second airplane parking floor regions (62) to and/or from the fixed sector (24) at the first elevation; and in response to receiving the command, actuating the electrical switch to selectively supply power to one or a combination of the means for rotating the first airplane parking floor (50), the means for rotating the second airplane parking floor (60), the means for limiting rotational of the airplane parking floors, and the elevator (90) in such a sequence so as to implement the command. In embodiments, the command may comprise an authentication key. The step of actuating the electrical switch is conditional on the authentication key matching data stored in the computer memory and uniquely associated with the selected one of the first airplane parking floor regions (54) or second airplane parking floor regions (62). In exemplary embodiments, as non-limiting examples, the authentication key may comprise a password (a string of characters), or data encoding an image (e.g., an image created by a finger print scanner, a retinal scanner or other suitable type of biometric scanner known in the art). Accordingly, the computer may fully or at least partially automate movement of the selected one of the first airplane parking floor regions (54) or the second airplane parking floor regions (62) to and/or from the fixed sector (24) at the first elevation, and selectively control access to the associated airplane parking compartments to an operator who is able to provide the authentication key uniquely associated with such airplane parking floor compartment.

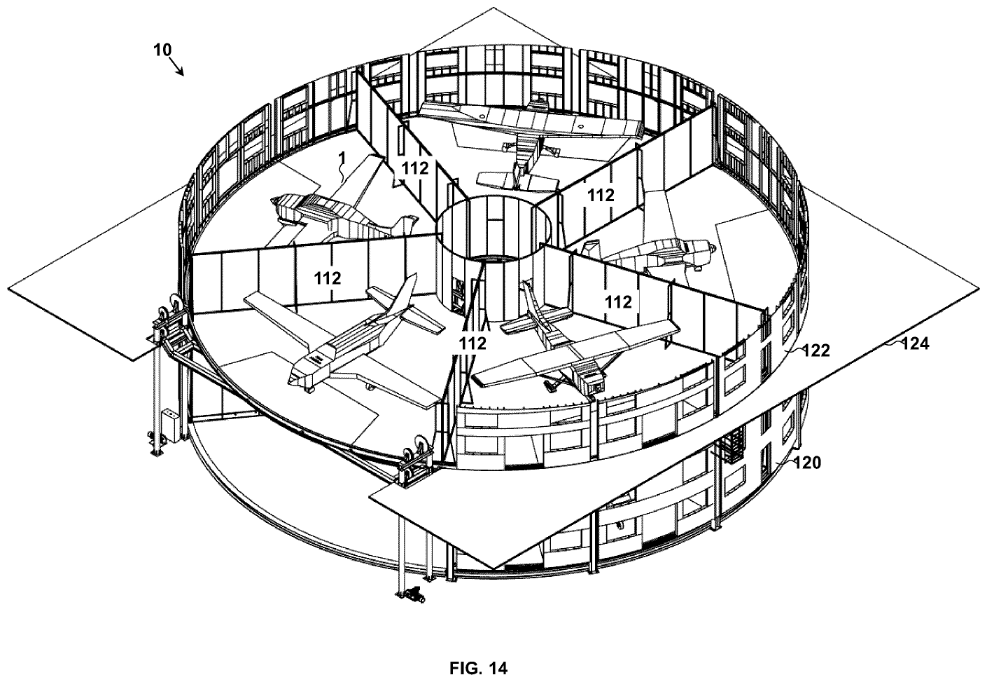

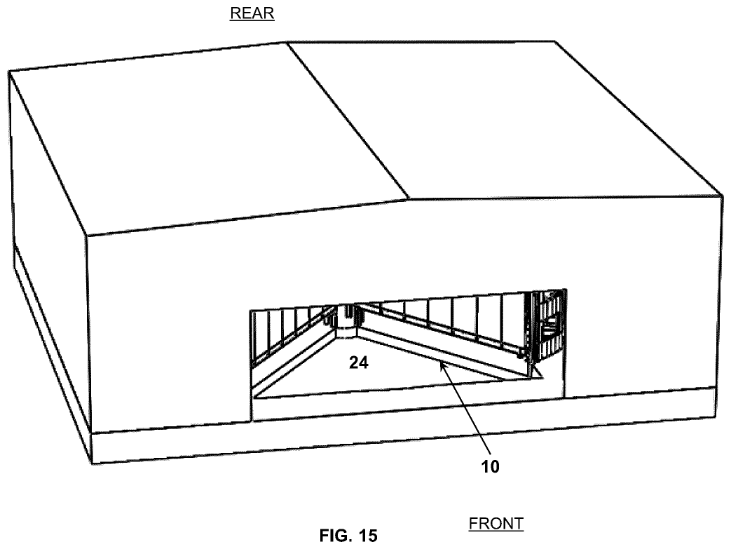

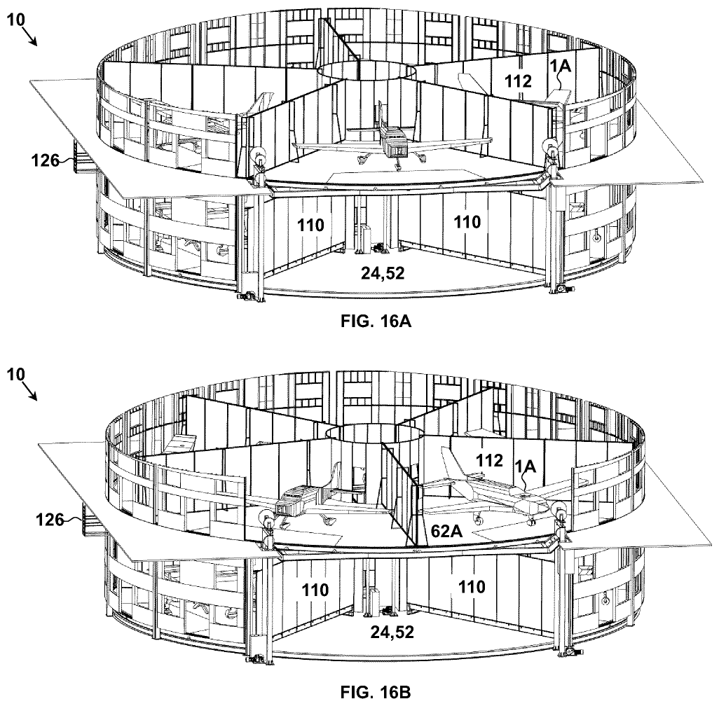

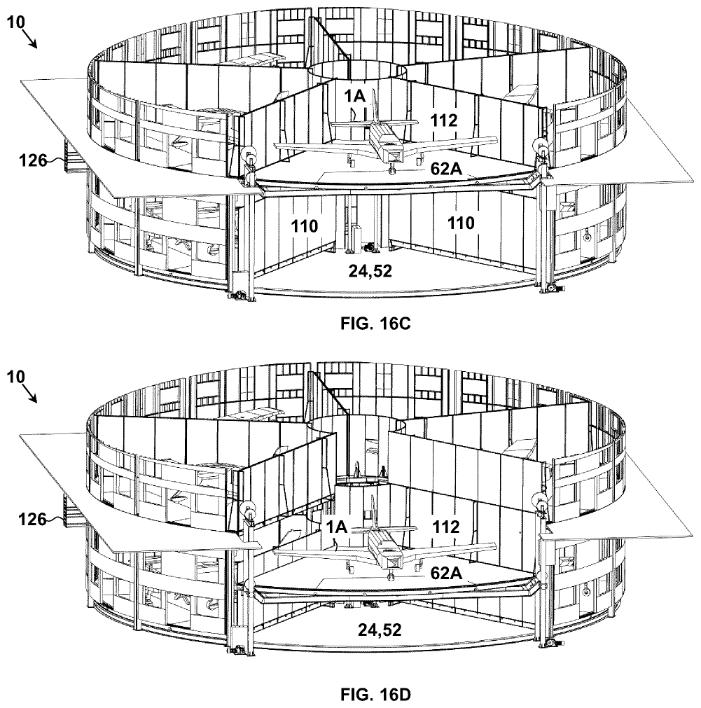

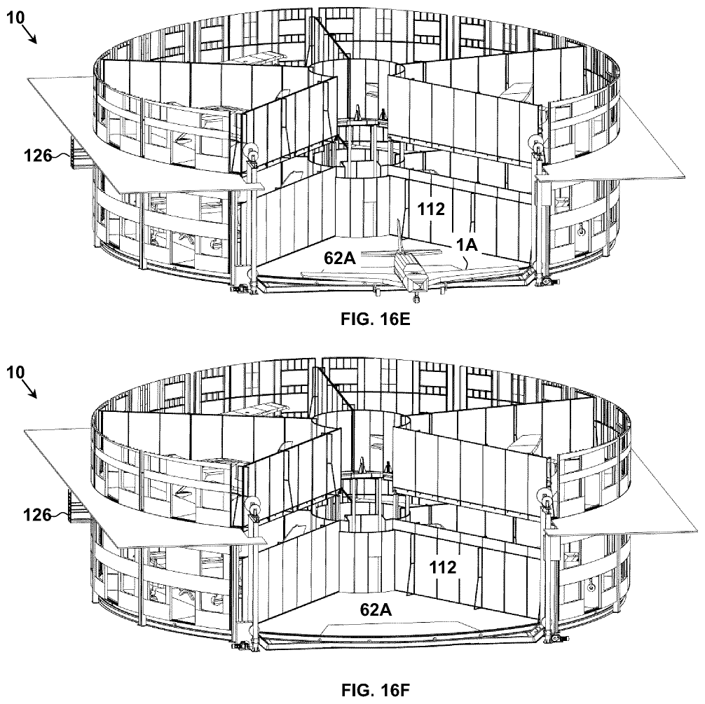

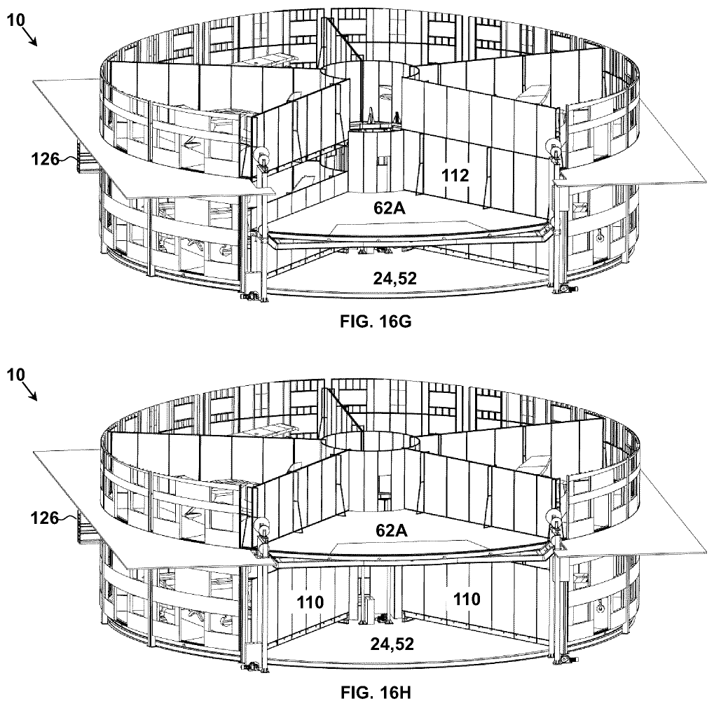

Walls for delineation of airplane parking floor regions. In the exemplary embodiment shown in FIGS. 14 and 16A-16H, the apparatus further comprises pairs of first walls (110) and pairs of second walls (112).

A purpose of the first walls (110) and the second walls (112) is to delineate first airplane parking floor regions (54) and second airplane parking floor regions (62), respectively. Another purpose of the first walls (110) and the second walls (112) may be to provide a barrier between first airplane parking floor regions (54) and second airplane parking floor regions (62), respectively. Another purpose of the first walls (110) and the second walls (112) may be to control airflow (e.g., for climate control purposes) between first airplane parking floor regions (54) and second airplane parking floor regions (62), respectively. In the exemplary embodiment, the first walls (110) in combination with the first airplane parking floor (50), effectively define a plurality of partitioned, airplane parking compartments at the first elevation. Likewise, in the exemplary embodiment, the second walls (112) in combination with the second airplane parking floor (60), effectively define a plurality of partitioned, airplane parking compartments at the second elevation.

In the exemplary embodiment shown in FIGS. 14 and 16A-16H, the pairs of first walls (110) and the pairs of second walls (112) are attached to and extend upwardly from the first airplane parking floor (50) and the second airplane parking floor (60), respectively. The first walls (110) and the second walls (112) can have a height of about 4 meters (14 feet) to provide a barrier to a human in one of the parking floor regions from accessing an adjacent one of the parking floor regions. In other embodiments (not shown) the first walls (110) and the second walls (112) can have a height greater than or less than about 4 meters (14 feet). In other embodiments (not shown), the heights of the first walls (110) and the associated heights of the structure inner columns (32) and structure outer columns (34), may be selected to be different than the heights of the second walls (112).

Access Floor and Access Walls. In the exemplary embodiment shown in FIGS. 14 and 16A-16H, the apparatus further comprises a first access walls (120) rising vertically from the first elevation, second access walls (122) rising vertically from the second elevation, and an access floor (124) at the second elevation.

A purpose of the first access walls (120) and the second access walls (122) may be to provide an outer barrier to the first airplane parking floor regions (54) and the second airplane parking floor regions (62), respectively. Another purpose of the first access wall (120) and the second access wall (122) may be to control air flow (e.g., for climate control purposes) to and from the first airplane parking floor regions (54) and the second airplane parking floor regions (62), respectively. In the exemplary embodiment shown in FIGS. 14 and 16A-16H, the first access walls (120) and the second access walls (122) extend along an outer edge of one of the first airplane parking floor regions (54) and the second airplane parking floor regions (62), respectively. In the exemplary embodiment, the first access wall (120) is not attached to the first airplane parking floor (50) and remains stationary when the first airplane parking floor (50) rotates about the circumcenter (22). Likewise, in the exemplary embodiment, the second access wall (122) is not attached to the second airplane parking floor (60) and remains stationary when the second airplane parking floor (60) rotates about the circumcenter. Further, the first access walls (120) and the second access walls (122) define door openings allowing a human to move into and out of the first airplane parking floor regions (54) and the second airplane parking floor regions (62), respectively. The doors may be secured with locks to restrict access to each airplane parking floor region to an authorized operator.

In other embodiments (not shown), the first access wall (120) is attached to the first airplane parking floor (50) and rotates with the first airplane parking floor (50) as it rotates about the notional circumcenter (22). Likewise, in other embodiments (not shown), the second access wall (122) is attached to the second airplane parking floor (60) and rotates with the second airplane parking floor (60) as it rotates about the notional circumcenter (22). In such other embodiments, the first access wall (120) or the second access wall (122) may define openings for ingress and egress of an airplane to and from the first airplane parking floor (50) or second airplane parking floor (60), respectively.

A purpose of the access floor (124) is to provide access to the second airplane parking floor (60). In the exemplary embodiment shown in FIGS. 14 and 16A-16H, the access floor (124) is adjacent to a portion of the edge of the second airplane parking floor (60), and extends radially away from the notional circumcenter (22). The access floor (124) may be accessed by a stairway (126), ladder, or a lift between the first elevation or the second elevation.

Use and operation of apparatus. The apparatus (10) may be installed within a hangar (as shown in FIG. 15) and oriented so that the fixed sector (24) is aligned with and proximal to a hangar opening for entry and exit of the airplanes from the hangar. It will be understood that in this exemplary use, the first elevation is at ground level and level with the top surface of an apron in front of a hangar door, and the second elevation is above ground level, but as previously noted, the second elevation may be below ground level.

FIGS. 16A to 16H illustrate an exemplary use and operation of the apparatus (10). In the exemplary embodiment where the first airplane parking floor (50) is rotatable about the notional circumcenter (22). As such, the first airplane parking floor (50) is rotated about the notional circumcenter (22), as necessary, so that the vacant region is in angular alignment with the fixed sector (24), as shown in FIG. 16A. For convenient discussion, the fixed sector (24) is hereinafter referred to as a “home position”.

Airplane (1A) is selected for movement from the second elevation to the first elevation. Accordingly, the second airplane parking floor (60) is rotated about the notional circumcenter (22), as shown in FIG. 16B, until the second airplane parking floor region (62A) supporting the airplane (1A), is in angular alignment with the home position, as shown in FIG. 16C.

When so aligned, the second airplane parking floor region (62A) is selectively engaged by the elevator (90), as described above. The elevator (90) is then actuated to lower the second airplane parking floor region (62A) from the second elevation, as shown in FIG. 16D, until the second airplane parking floor region (62A) is placed into the vacant region (52) at the first elevation, as shown in FIG. 16E. The airplane (1A) may then be moved off of the second airplane parking floor region (62A) such as by towing the airplane by hand or by another vehicle (e.g., a tug, a tractor, or all-terrain vehicle), or by driving under its own power off the second airplane parking floor region (62A), and through the opening of the hangar.

The elevator (90) is then actuated to raise the second airplane parking region (62A) as shown in FIGS. 16F to 16G, until it returns to the second elevation, as shown in FIG. 16H. The apparatus (10) is again ready to move airplanes onto or off of other ones of the first airplane parking floor regions (54) or the second airplane parking floor regions (62). In exemplary embodiments, the foregoing movement of the first airplane parking floor regions (54) and second airplane parking floor regions (62) may be partially or fully automated with the use of a computerized means for controlling the apparatus (10), as discussed above, in response to receiving a command through an operatively connected input device.

It will be appreciated that in exemplary embodiments of the apparatus (10), the footprint of the apparatus (10) may be confined to the footprint of the notional circle (20) that circumscribes the first airplane parking floor (50). Further, in exemplary embodiments of the apparatus (10), it is unnecessary to move airplanes (1) on or off the second airplane parking floor regions (62) until such regions are moved to the ground level. Accordingly, exemplary embodiments of the apparatus (10) may allow for an unassisted single operator of the apparatus (10) to move airplanes between the first elevation and the second elevation. Further, in exemplary embodiments of the apparatus (10), the first walls (110), second walls (112), first access wall (120) and second access walls (122) may enhance security of airplanes stored in the apparatus (10) by restricting access to the first airplanes parking floor regions (54) and the second airplane parking floor regions (62), as the case may be, to an authorized operator. Further, in exemplary embodiments of the apparatus (10), the first walls (110), second walls (112), first access wall (120) and second access walls (122) may enhance climate control within the hangar by controlling air flow to the airplanes when a hangar door is opened to allow airplanes to enter and exit. It will be understood, however, that the foregoing aspirations of the present invention are not promised advantages of any particular embodiment of the present invention.

The present invention has been described above and shown in the drawings by way of exemplary embodiments and uses, having regard to the accompanying drawings. The exemplary embodiments and uses are intended to be illustrative of the present invention. It is not necessary for a particular feature of a particular embodiment to be used exclusively with that particular exemplary embodiment. Instead, any of the features described above and/or depicted in the drawings can be combined with any of the exemplary embodiments, in addition to or in substitution for any of the other features of those exemplary embodiments. One exemplary embodiment's features are not mutually exclusive to another exemplary embodiment's features. Instead, the scope of this disclosure encompasses any combination of any of the features. Further, it is not necessary for all features of an exemplary embodiment to be used. Instead, any of the features described above can be used, without any other particular feature or features also being used. Accordingly, various changes and modifications can be made to the exemplary embodiments and uses without departing from the scope of the invention as defined in the claims that follow.

1. An apparatus for storing airplanes, the apparatus comprising:
(a) a first airplane parking floor at a first elevation, wherein the first airplane parking floor is shaped to define a vacant region at the first elevation in which the first airplane parking floor is absent, wherein the vacant region is positioned within a notional circle at the first elevation circumscribing the first airplane parking floor and defining a notional circumcenter;
(b) a second airplane parking floor at a second elevation different from the first elevation, wherein the second airplane parking floor comprises a plurality of separable second airplane parking floor regions, each of which is proportioned for parking one of the airplanes thereon, wherein the second airplane parking floor is rotatable about the notional circumcenter for selective angular alignment of an individual one of the second airplane parking floor regions with the vacant region; and
(c) an elevator for vertically translating the individual one of the second airplane parking floor regions, when in angular alignment with the vacant region, between the second elevation and the vacant region at the first elevation.

2. The apparatus of claim 1 wherein:
(a) the first airplane parking floor comprises a plurality of first airplane parking floor regions, each of which is proportioned for parking one of the airplanes thereon; and
(b) the first airplane parking floor is rotatable about the circumcenter, for selective angular alignment of an individual one of the first airplane parking floor regions or the vacant region with a fixed sector of the notional circle.

3. The apparatus of claim 2 wherein the plurality of first airplane parking floor regions are separable from each other.

4. The apparatus of claim 2 wherein the apparatus further comprises at least one pair of first walls attached to and extending upwardly from the first airplane parking floor for separating one of the first airplane parking floor regions from an adjacent one or adjacent ones of the first airplane parking floor regions.

5. The apparatus of claim 2 further comprising a first access wall extending along an outer edge of one of the first airplane parking floor regions.

6. The apparatus of claim 5 wherein the first access wall is stationary when the first airplane parking floor rotates about the circumcenter.

7. The apparatus of claim 1 wherein the apparatus further comprises at least one pair of second walls attached to and extending upwardly from the second airplane parking floor for separating one of the second airplane parking floor regions from an adjacent one or adjacent ones of the second airplane parking floor regions.

8. The apparatus of claim 1 further comprising an access floor at the second elevation, adjacent to at least a portion of an edge of the second airplane parking floor, and extending radially away from the notional circumcenter.

9. The apparatus of claim 1 further comprising a second access wall extending along an outer edge of one of the second airplane parking floor regions.

10. The apparatus of claim 9 wherein the second access wall is stationary when the second airplane parking floor rotates about the circumcenter.

11. The apparatus of claim 1 wherein the elevator is positioned to selectively engage the individual one of the second airplane parking floor regions in angular alignment with the vacant region, without engaging the other one or ones of the second airplane parking floor regions not in angular alignment with the vacant region.
